(19) United States
(12) Patent Application Publication
(10) Pub. No.: US 2016/0003612 A1
(43) Pub. Date: Jan. 7, 2016

(54) RAPID AND ACCURATE THREE DIMENSIONAL SCANNER

(71) Applicant: VirtualU, Blacksburg, VA (US)

(72) Inventors: Louis R. Cirillo, Blacksburg, VA (US); Nicholas Graber, Blacksburg, VA (US); Minahm Kim, Blacksburg, VA (US); Evan Lobeto, Blacksburg, VA (US)

(21) Appl. No.: 14/790,181

(22) Filed: Jul. 2, 2015

Related U.S. Application Data
(60) Provisional application No. 62/021,320, filed on Jul. 7, 2014.

(51) Int. Cl. G01B 11/24; H04N 5/33; H04N 13/02

(52) U.S. Cl. CPC G01B 11/24; H04N 13/0239; H04N 13/0253; H04N 13/0282; H04N 5/33

(57) ABSTRACT

A scanner system may include at least one linear actuator and/or at least one scanning platform on each of the at least one linear actuator. Each scanning platform may include an optical sensor configured to detect a two-dimensional contour on an object from a position on the at least one linear actuator, the at least one linear actuator moves a respective scanning platform linearly along a respective axis, and the scanner system records a group of two-dimensional contours of the object detected by the optical sensor of each scanning platform at a group of positions on the at least one linear actuator to compose a three-dimensional contour of the object.

### CROSS-REFERENCE TO RELATED APPLICATIONS

This patent application claims the benefit of U.S. Provisional Patent Application No. 62/021,320, filed Jul. 7, 2014, which is incorporated by reference.

### BACKGROUND OF THE INVENTION

The present disclosure generally relates to systems and methods of rapid and accurate three dimensional (3D) scanning of object contours and processing of the three dimensional contour data, for example, for scanning the contour of the body of a user.

In order to obtain sufficiently detailed and accurate 3D contour data of objects, typical 3D scanner systems may need to include complex components, which may be too costly for general public use. Additionally, even with very complex components, the 3D scanner systems may require a significant amount of time to perform each scan accurately. This long scan duration also makes public use impractical.

Thus, there is a continual need for cost effective 3D scanner systems that can perform 3D scans quickly and accurately, and that can provide rich user interactive experience with web interfaces and mobile devices.

### BRIEF SUMMARY OF THE INVENTION

A scanner system may include at least one linear actuator and/or at least one scanning platform on each of the at least one linear actuator. Each scanning platform may include an optical sensor configured to detect a two-dimensional contour on an object from a position on the at least one linear actuator, the at least one linear actuator moves a respective scanning platform linearly along a respective axis, and the scanner system records a group of two-dimensional contours of the object detected by the optical sensor of each scanning platform at a group of positions on the at least one linear actuator to compose a three-dimensional contour of the object.

### BRIEF DESCRIPTION OF THE SEVERAL VIEWS OF THE DRAWING(S)

FIG. 1 illustrates an exemplary 3D scanner system according to an embodiment.

FIG. 2 illustrates an exemplary scanning platform in an exemplary 3D scanner system according to an embodiment.

### DETAILED DESCRIPTION OF THE INVENTION

In some embodiments, a scanner system may include at least one linear actuator and/or at least one scanning platform on each of the at least one linear actuator. Each scanning platform may include an optical sensor configured to detect a two-dimensional contour on an object from a position on the at least one linear actuator, the at least one linear actuator moves a respective scanning platform linearly along a respective axis, and the scanner system records a group of two-dimensional contours of the object detected by the optical sensor of each scanning platform at a group of positions on the at least one linear actuator to compose a three-dimensional contour of the object.

In some embodiments, such a scanner system may further include a weight scale configured to measure weight of the object.

In some embodiments, the scanner system determines volume of the object.

In some embodiments, the scanner system determines density of the object based on the volume and the weight of the object.

In some embodiments, the object is a human body, and the scanner system determines body fat percentage of the human body.

In some embodiments, the scanner system determines dimensions of different portions of the object.

In some embodiments, the at least one linear actuators are positioned at a periphery of a scanning space around the object.

In some embodiments, the respective axis of the at least one linear actuator is a straight line or a spiral line.

In some embodiments, the optical sensor may include an emitter configured to emit a beam that intersects the object to form an outline of the two-dimensional contour under scan and at least two cameras configured to capture images of the outline simultaneously from respective different angles.

In some embodiments, the emitter is an infrared laser, and the at least two cameras are infrared cameras configured to capture infrared images.

In some embodiments, the scanner system determines the two-dimensional contour of the object in three-dimensional space by triangulating the images of the outline from the at least two cameras.

In some embodiments, such a scanner system may further include a texture camera configured to capture images of surface texture of the object.

In some embodiments, the scanner system superimposes texture information onto the three-dimensional contour of the object based on the images of the surface texture of the object to form a three-dimensional model of the object.

The following examples further illustrate the invention but, of course, should not be construed as in any way limiting its scope.

### Hardware

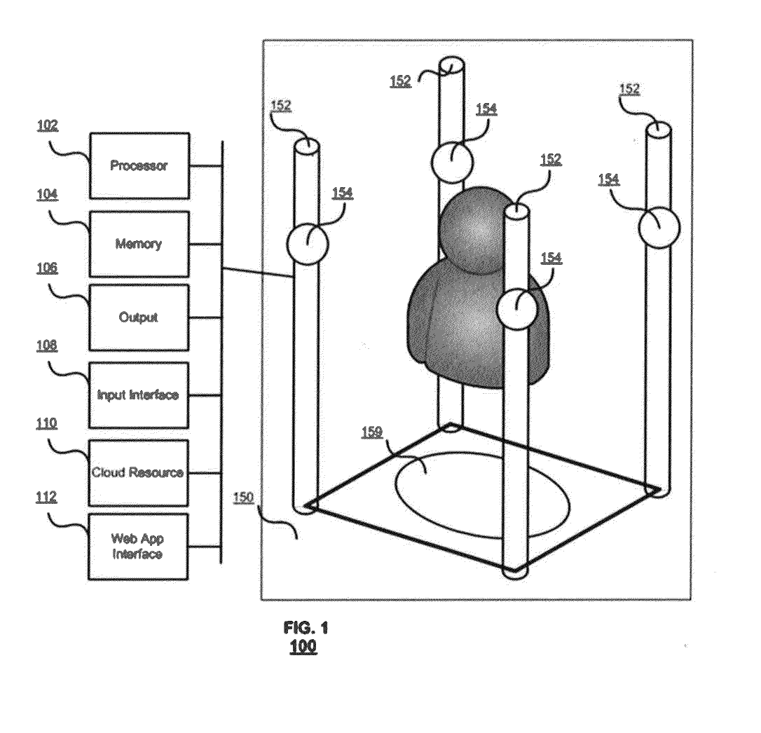

FIG. 1 illustrates an exemplary 3D scanner system 100 according to an embodiment. The scanner system 100 may include a scanner 150, a processor 102, a memory 104, an output 106, an input interface 108, cloud resources 110, and web application interface 112, connected to each other via a bus.

The processor 102 may include multiple cores capable of executing program instructions. The memory 104 may include volatile or non-volatile memory for storing instructions or data. The memory 104 may include a non-volatile computer readable medium, such as a magnetic hard drive, a CD-ROM, a flash drive, a ROM memory, an EEPROM memory. The output 106 may include a display screen, a printer, audio output devices, etc. The input interface 108 may include a touch pad, a touch screen, a mouse, keyboard, etc.

The scanner 150 may include a plurality of linear actuators 152, each having a scanning platform 154 that the respective linear actuator 152 may move in a linear direction. The scanner 150 may optionally include a weighing scale 159, to weigh an object under scan.

In FIG. 1, four linear actuators 152 are shown, surrounding a user's body as an object under scan, so to form a rectangular cylindrical scanning space between the four linear actuators 152. However, fewer or more of the linear actuators 152 may be implemented in a 3D scanning system 100.

In FIG. 1, the four linear actuators 152 are shown as each having a straight line actuator axis and each being placed vertically, so to allow the scanning platforms 154 to move vertically, up and down, to perform the scan. However, the linear actuators 152 may be placed in other orientations, or have other non-straight line actuator axes, as long as the orientations are known or measured and factored into the calculation of the 3D contour point data. For example, the linear actuators 152 may each have a spiral actuator axis. There may be only one linear actuator 152 with a spiral actuator axis, such that the one linear actuator 152 forms a round cylindrical scanning space within the one linear actuator's spiral.

The scanning platforms 154 are oriented so that they may perform scanning of the scanning space between the linear actuators 152. The scanning platforms 154 each perform a scan from their respective scanning position and angle of view from their positions along the linear actuators 152. As the linear actuators 152 move the scanning platforms 154, additional scanned data are obtained from the object under scan. All of the data are gathered for processing and/or analysis by the processor 102, and memory 104 may store the data.

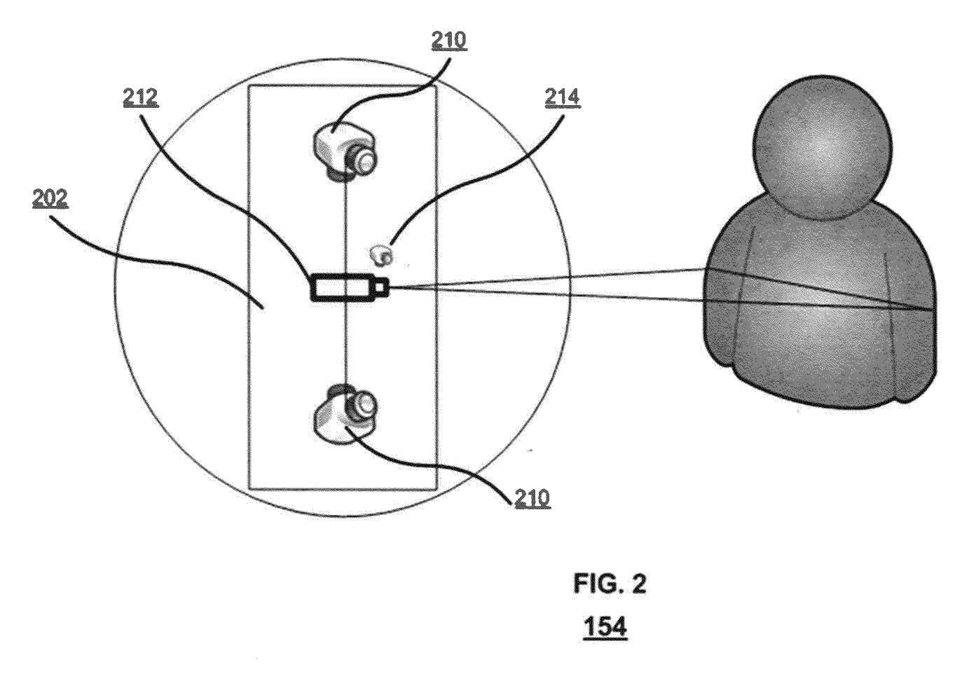

FIG. 2 illustrates an exemplary scanning platform 154 in an exemplary 3D scanner system 100 according to an embodiment.

In each exemplary scanning platform 154 according to an embodiment, there may include a mount 202, on which there may be mounted a laser 212, a visual camera 214, and at least two infrared (IR) cameras 210. The laser 212, the visual camera 214, and at least two infrared cameras 210 may all be pointed toward the same general direction, toward the inside of the scanning space, and may be approximately aligned in their horizontal angle of orientation, such that their optical axes may be approximately coplanar to a vertical plane.

The visual camera 214 may be located approximately at the center of the mount 202, oriented such that the visual camera 214 captures visual images at a horizontal direction from the scanning space (for example, from the right in FIG. 2).

The laser 212 may be located approximately at the center of the mount 202 (close to the visual camera 214), oriented such that the laser 212 emits a laser beam at a horizontal direction toward the scanning space (for example, toward the right in FIG. 2). The laser 212 may emit a laser beam with a narrow vertical fanning angle (for example, <1 degree), and a wider horizontal fanning angle (for example, 120 degrees). In this fashion, the laser 212 may emit a laser beam that intersects the contour of the object under scan, and the intersection forms a horizontal two-dimensional outline (a section of a slice) in the three-dimensional scanning space. Alternatively, the laser 212 may emit a laser beam with a narrow fanning angle vertically and horizontally, and the laser 212 sweeps the laser beam horizontally at an angle. Additionally, the laser 212 may include multiple laser emitters, or emit a laser grid with fanning or sweeping angles in both vertical and horizontal directions. However, the sweeping laser beam may require additional time to scan each horizontal slice.

The laser 212 preferably emits non-visible laser light, such as IR laser light, preferably at 980 nm wavelength and preferably at sufficiently low intensity to prevent exposing the user to harmful IR radiation.

The at least two infrared cameras 210 may be mounted on the mount 202, with some predetermined distances between them, and from the laser 212. For example, one of the IR cameras 210 may be placed three inches above the laser 212, and the other IR camera 210 may be placed three inches below the laser 212. At any specific position of the scanning platform 154, the at least two infrared cameras 210 may simultaneously capture IR images of the horizontal slice contour from at least two different perspectives, as at least two different image frames. The at least two different image frames from at least two different perspectives may be analyzed to triangulate the horizontal slice contour outline points' positions (X and Y coordinates) relative to the position of the scanning platform 154, at specific Z position.

The at least two infrared cameras 210 may be each oriented to be parallel to the optical axis of the laser 212, or may be each oriented at some predetermined angle relative to the optical axis of the laser 212. The at least two infrared cameras 210 may each be fitted with optical filters, such that the at least two infrared cameras 210 each only capture images in the wavelength of light of the laser 212. That is, the at least two infrared cameras 210 may only capture preferably the images of the two-dimensional horizontal slice outlines formed by the IR laser of the laser 212 intersecting the contour of the object under scan.

As long as factors, such as the positions and orientations of the scanning platforms 154, the separation distances between the at least two infrared cameras 210 from each other and from the laser 212, and the offset angles of orientation of the at least two infrared cameras 210, and the height of the scanning platform 154, are known, the image recorded by at least two infrared cameras 210 of the multiple scanning platforms 154 may be used to triangulate and obtain three dimensional coordinates of contours of each individual horizontal slices of the object under scan. As the scanning platforms 154 are moved along the actuators' axes, additional slices may be scanned and analyzed to obtain the complete three-dimensional contour data set for the object under scan. The visual camera 214 may obtain visible images to be used for texture data to overlay a 3D contour image to provide a realistic 3D model of the object under scan.

The first time use of the exemplary scanner system 100 may require calibrations of the weighing scale 159 for measuring weight and calibration of the analysis parameters to compensate for slight position and angle deviations of the actuators 152, the scanning platforms 154, the IR cameras 210, the laser 212, and the visual camera 214. Once the calibrations are complete, the scanner system 100 may be able to scan any object inside and produce accurate results. A specific file type, for example in .obj format, may be made by appending vertices, normals to the vertices, triangular faces, and texture coordinates to a single file per linear actuator of data. Using the point cloud to find the height and data points per height layer a volume can be generated and analyzed via exemplary methods described below.

The exemplary scanner system 100 thus may generate three dimensional point cloud models and perform various analysis of the data.

In the exemplary scanner system 100, to allow for fast scanning and data analysis, it may be preferred that the IR cameras 210 and the visual camera 214 capture their respective image data quickly. This may be accomplished by the IR cameras 210 and the visual camera 214 capturing their respective image data as video data, compressed for fast storage and/or transmission. Each of the IR cameras 210 and the visual camera 214 may capture the video data, for example, in the format of 1920×1080 pixel resolution at 30 frames per second. Additionally, while the video data are being captured, portions of the video data may be processed and analyzed to extract 3D contour data, at the same time as the scanner system 100 continue to capture additional video data. To accomplish this, individual components, such as the linear actuators 152, the scanning platform 154, etc. may have their own microcontrollers to perform their respective functions in parallel. In this fashion, image capture and data analysis may be performed separately and in parallel fashion.

The data analysis of the video data may be performed by the processor 102, by for example, decompressing the video data, and analyzing the frames individually to triangulate 3D point positions. Additionally, some or all of the data analysis of the video data may be performed by cloud resources 110, such as cloud servers, by sending the video data to the cloud resources 110 for data analysis. The cloud resources 110 may then return the results of data analysis back to the processor 102, and/or to the output 106, the memory 104, or the web application interface 112 for output. The input interface 108 may receive various inputs from the user to control the scanning process and the data analysis. The scanner system 100 may also receive various inputs to control the scanning process and the data analysis from mobile devices through the web application interface 112.

The calibration may be completed by placing an object of known size, such as a cube, into the center of the scanning space, and running a scan on it. The data is analyzed, and then error correction is done to various position and angle presets, and the data is reanalyzed until the resulting 3D model matches closely to the cube of known size. After the calibration, the scanner system 100 may be ready to perform rapid and accurate scanning. Periodically, the scanner system 100 may need to be re-calibrated again using an object of known size, to compensate for changes in errors over time, due to temperature changes, wear and tear during use, etc.

### Data Cleaning

Due to the detailed scanning, extremely dense lines of data points may be extracted in each horizontal slice. Additionally, the multiple scanning stages 154 may produce data points overlapping in the same scanning area of the 3D contour. The excess density of data points is redundant and cumbersome for storage and analysis. In order to make the data more manageable, by consolidating data points, for example by taking each group of 10 data points and weight averaging the 10 points to generate an average point coordinate. Additionally, some smooth surface regions have very little features of interests, such regions may have even more data points cleaned by weight averaging. The “cleaned” data may then be used in subsequent functions to produce the 3D model.

### Data Smoothing

Using the cleaned data, data points may be smoothed to remove noise in data points. For example, each group of 6 data points may be averaged to obtain an average point. Then each of the 6 data points may be adjusted or re-positioned closer to the average point proportionally. That is, each of the 6 data points may move closer to the average point proportionally based upon the distances of each of the 6 data points from the average point. This smoothing may be executed in a non-progressive manner, meaning that each group of data point is used for a single iteration of smoothing. This process is then executed multiple times, producing progressively smoother sets of data points.

### Data Filtering

In order to reduce outlier points and other extraneous sections of data points, data filtering may performed. For example, for each data point, it may be determined the number of data points that exist within a predetermined bound/distance from the data point. If the target data point has too few or too many points, the target data point may be ignored and removed from the data set as an outlier.

### Adding Triangle Surfaces

The smooth, filtered data set may be loaded in a sorted double array, or a float array or any other types of numerical array, separated into sets of data by height, with one set of data for each height coordinates. Then, for each data point, the data point may be compared to the row/set of data points below in height. The two closest (by distance) data points are found, and a triangle surface may be formed with the 3 points and may be added to the 3D model. In order to fill in the spaces between the triangles, a previous data point in the same row as the target data point may be located, and a data point of the row below closest to the 2 data points in the same row may be found to form an adjacent triangle. This may be performed continuously over all the data points in a linear fashion, and all the triangles may be added to the 3D model continuously.

### Adding Surface Normals

For each data point, surface normal vectors may need to be added to the 3D model. For each data point, the closest points that exist in the row below (or above) may be located, and a cross product may be calculated to determine the normals. Given a triangular polygon with three vertices in the form (xₙ, yₙ, zₙ), it is possible to calculate the normal to that triangle by first describing two directional vectors in the same plane. For instance, given three points:

p₁=(x₁,y₁,z₁)

p₂=(x₂,y₂,z₂)

p₃=(x₃,y₃,z₃)

Two possible directional vectors representing the plane of that surface are:

d₁=(x₂−x₁,y₂−y₁,z₂−z₁)

d₂=(x₃−x₂,y₃−y₂,z₃−z₂)

In order to find a line perpendicular to those two vectors, it is necessary to find the cross product of these two vectors. Each component of the cross product (normal) vector is described below.

cross[x]=d₁[y]*d₂[z]−d₁[z]*d₂[y]

cross[y]=d₁[z]*d₂[x]−d₁[x]*d₂[z]

cross[z]=d₁[x]*d₂[y]−d₁[y]*d₂[x]

### Adding Texture

Texture image captured from the visual camera 214, where a slice of video from near the center of the frame may be taken/extracted and stitched together. Each of the texture files from the multiple visual cameras 214 from the multiple scanning stages may be turned into frames of individual images, which may be then stitched together to form a large texture file for the 3D contour model. The texture coordinates may be proportional positions, meaning that the coordinates are relative and do not care about the texture image. When building the 3D contour model, the coordinates of the data points in terms of pixel positions in the image may be calculated. These coordinates are then converted into proportional coordinates for the texture.

### Additional User Data Analysis

Body Mass Calculation:

Exemplary scanner system 100 may calculate an accurate body mass for a user through the volumetric analyses of an accurate 3D model of the body of the user. Provided that the equation is supplied with a lifelike and dimensionally correct 3D model, the system may generate an accurate volume analysis. The volume of the body is calculated by integrating/adding the area of each slice. The formula may be represented by V=integr(A)dx where the Volume of the object is the integral sum of the slices from x=0 to x=h (max height), the area of the slices represented by A is calculated internally through analysis of the 3D shape. Additionally, using the weighing scale 159 or a manually entered weight, the exemplary scanner system 100 may calculate body density using the volume analysis. This results in an accurate body mass of an individual. Output 106 or the web application interface 112 may output this body mass data for individual users. Additionally, the body mass data may be stored in memory 104 (for example in a database) for individual users.

Body Fat Percentage:

In addition to the body mass, the exemplary scanner system 100 may also calculate the body fat percentage of an individual user. Using the body volume calculated and the weight measured in the exemplary scanner system 100, as well as dimensions of different body parts, the exemplary scanner system 100 may be able to calculate an accurate body fat percentage. Output 106 or the web application interface 112 may output this body fat percentage data for individual users. Additionally, the body fat percentage data may be stored in memory 104 (for example in a database) for individual users.

In the case of the body fat percentage, the density of body fat is a known number as is the density of lean muscle. Using the calculated body density, the following equation may be used to solve FM. D=FM+LM[FMf)+(LMlm)]

### Where:

FM=Proportion of body mass that is fat.
LM=Portion of the body mass that is lean muscle ˜=100%−FM.
f=fat density
lf=density of lean muscle mass

Circumference and Body Dimension of Different Body Parts:

The exemplary scanner system 100 may calculate or virtually measure a circumference or length of any part of their body, for example, waist size, collar size, height, inseam length, etc. This information may be outputted or stored for individual users over time. Additionally, these calculated results may also feed into other calculations, such as the body fat equation.

Visual Shading Tool:

A shading tool may be implemented in the exemplary scanner system 100, which allows a user to compare different scans. This tool may graphically superimpose shading/highlight colors over the 3D model in different colors, for regions where shape changed, representing where fat is lost and/or muscle is gained.

Body Scoring:

The exemplary scanner system 100 may calculate various health scores or an overall health score, based upon various above data calculated from body dimension, body mass, body density, body fat percentage, etc. Such health scores may be based upon a standardized scale, or relative to known population averages and statistics. Additionally, users may share health scores with each other.

Children may be scanned to track their growth and development over time.

Body Selfie:

The exemplary scanner system 100 may allow users to share individual snapshot images of their 3D models selected from various different times to various social media as a “Body Selfie”, via for example, web application interface 112.

Challenge Other Users:

The exemplary scanner system 100 may allow users to challenge other friends and users to lose weight, build muscle, or even against specific body parts. Scanned images of different users may be compared over time against each other and/or against individual users, to determine for example, who lost the most weight, who gained the most muscle, etc.

Competitions may be run in groups of users and users may be ranked. The exemplary scanner system 100 may allow tracking of all competing users' data over a period of time, or indefinitely.

The individual users' data may also be collected for overall statistical analysis of larger set of user groups, in for example, a city, a region, a state, a country, or even around the world.

It is appreciated that the disclosure is not limited to the described embodiments, and that any number of scenarios and embodiments may exist.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

The present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A scanner system, comprising:
at least one linear actuator; and
at least one scanning platform on each of the at least one linear actuator,
wherein each scanning platform comprises an optical sensor configured to detect a two-dimensional contour on an object from a position on the at least one linear actuator,
the at least one linear actuator moves a respective scanning platform linearly along a respective axis, and
the scanner system records a plurality of two-dimensional contours of the object detected by the optical sensor of each scanning platform at a plurality of positions on the at least one linear actuator to compose a three-dimensional contour of the object.

2. The scanner system of claim 1, further comprising a weight scale configured to measure weight of the object.

3. The scanner system of claim 1, wherein the scanner system determines volume of the object.

4. The scanner system of claim 3, wherein the scanner system determines density of the object based on the volume and the weight of the object.

5. The scanner system of claim 4, wherein the object is a human body, and the scanner system determines body fat percentage of the human body.

6. The scanner system of claim 1, wherein the scanner system determines dimensions of different portions of the object.

7. The scanner system of claim 1, wherein the at least one linear actuators are positioned at a periphery of a scanning space around the object.

8. The scanner system of claim 1, wherein the respective axis of the at least one linear actuator is a straight line or a spiral line.

9. The scanner system of claim 1, wherein the optical sensor includes an emitter configured to emit a beam that intersects the object to form an outline of the two-dimensional contour under scan and at least two cameras configured to capture images of the outline simultaneously from respective different angles.

10. The scanner system of claim 9, wherein the emitter is an infrared laser, and the at least two cameras are infrared cameras configured to capture infrared images.

11. The scanner system of claim 9, wherein the scanner system determines the two-dimensional contour of the object in three-dimensional space by triangulating the images of the outline from the at least two cameras.

12. The scanner system of claim 1, further comprising a texture camera configured to capture images of surface texture of the object.

13. The scanner system of claim 12, wherein the scanner system superimposes texture information onto the three-dimensional contour of the object based on the images of the surface texture of the object to form a three-dimensional model of the object.

14. A method for scanning in a scanner system, comprising:
detecting, by an optical sensor of each of at least one scanning platform on each of at least one linear actuator, a two-dimensional contour on an object from a position on at least one linear actuator;
moving, by the at least one linear actuator, a respective scanning platform linearly along a respective axis;
recording, by the scanner system, a plurality of two-dimensional contours of the object detected by the optical sensor of each scanning platform at a plurality of positions on the at least one linear actuator to compose a three-dimensional contour of the object.

15. The method of claim 14, further comprising weighing, by a weight scale, weight of the object.

16. The method of claim 14, further comprising determining, by the scanner system, volume of the object.

17. The method of claim 16, further comprising determining, by the scanner system, density of the object based on the volume and the weight of the object.

18. The method of claim 17, wherein the object is a human body, and the scanner system determines body fat percentage of the human body.

19. The method of claim 14, further comprising determining, by the scanner system, dimensions of different portions of the object.

20. A non-transitory computer readable storage medium, storing computer instructions executable by a processor to control a scanner system to perform:
detecting, by an optical sensor of each of at least one scanning platform on each of at least one linear actuator, a two-dimensional contour on an object from a position on at least one linear actuator;
moving, by the at least one linear actuator, a respective scanning platform linearly along a respective axis;
recording, by the scanner system, a plurality of two-dimensional contours of the object detected by the optical sensor of each scanning platform at a plurality of positions on the at least one linear actuator to compose a three-dimensional contour of the object.
